(19) United States
(12) Patent Application Publication
(10) Pub. No.: US 2026/0116345 A1
(43) Pub. Date: Apr. 30, 2026

(54) FLAT WIPER BLADE APPARATUS WITH LONGITUDINAL DETACHMENT PREVENTION STRUCTURE OF BLADE RUBBER

(71) Applicant: DY AUTO Corporation, Asan-si (KR)

(72) Inventor: Sang Kweon Lee, Asan-si (KR)

(73) Assignee: DY AUTO Corporation, Asan-si (KR)

(21) Appl. No.: 19/375,046

(22) Filed: Oct. 30, 2025

(30) Foreign Application Priority Data
Oct. 31, 2024 (KR) 10-2024-0152976

(51) Int. Cl. B60S 1/38

(52) U.S. Cl. CPC B60S 1/3863; B60S 1/3889

(57) ABSTRACT

A flat wiper blade apparatus with a longitudinal detachment prevention structure of a blade rubber includes a support member formed of a metal plate, a spoiler member including a tunnel-shaped support member accommodation portion to which the support member is coupled, a blade rubber holding portion arranged at a lower portion thereof, and a spoiler portion arranged at an upper portion thereof, a blade rubber coupled to the blade rubber holding portion, a connector arranged at a central portion of the support member and fixed to the spoiler member, a protruding stopper formed at one end portion of the spoiler member in a longitudinal direction and formed in a cantilever shape to protrude toward a center of the blade rubber in a width direction so as to limit movement of the blade rubber, and an engagement groove formed in the blade rubber to accommodate the protruding stopper.

### CROSS REFERENCE TO RELATED APPLICATION

This application is based on and claims priority under 35 U.S.C. § 119 to Korean Patent Application No. 10-2024-0152976, filed on Oct. 31, 2024, in the Korean Intellectual Property Office. The prior application is incorporated herein by reference in its entirety.

### FIELD

The disclosure relates to a wiper blade apparatus for a vehicle, and more particularly, to a flat wiper blade apparatus.

### BACKGROUND

A wiper apparatus for a vehicle is an apparatus that removes foreign objects from the front or rear windshield of the vehicle. The wiper apparatus is an important apparatus that ensures a driver's field of vision and allows for safe driving. The wiper apparatus may include a motor, a link structure, a wiper arm, and a wiper blade. Among these components, the wiper blade is a device that comes into direct contact with a windshield and removes foreign objects from the windshield. Recently, wiper blades employing a single frame having a thin, elongated bar shape bent at a certain curvature as a wiper blade frame have been used. Such wiper blades are known in the art as flat wiper blades or flat-bar wiper blades.

In general, a flat wiper blade apparatus includes a connector detachably coupled to a wiper arm, a spoiler coupled to the connector and associated with air flow, a support member (vertebra) that provides an elastic restoring force to the spoiler, and a blade rubber coupled to the spoiler and configured to remove foreign objects from a windshield.

In general, the flat wiper blade apparatus includes end caps at both end portions of the spoiler so as to prevent the blade rubber from being detached in a longitudinal direction, i.e., in a length direction of the blade rubber. However, the structure in which the end caps prevent the blade rubber from being detached in a longitudinal direction has a problem in that the blade rubber may be detached in a longitudinal direction of the spoiler when the end caps are unexpectedly separated. When such a phenomenon occurs while the vehicle is in operation, it may cause problems that could critically affect safe driving.

### SUMMARY

Provided is a flat wiper blade apparatus with an improved structure to prevent a blade rubber from being detached in a longitudinal direction of a spoiler.

Additional aspects will be set forth in part in the description which follows and, in part, will be apparent from the description, or may be learned by practice of the presented embodiments of the disclosure.

According to an aspect of the disclosure, a flat wiper blade apparatus with a longitudinal detachment prevention structure of a blade rubber includes a support member formed of a metal plate having an elongated bar shape, a spoiler member including a tunnel-shaped support member accommodation portion to which the support member is coupled, a blade rubber holding portion arranged at a lower portion thereof and to which a blade rubber is slidingly coupled, and a spoiler portion arranged at an upper portion thereof and configured to generate a pressing force downward due to air flow, a blade rubber coupled to the blade rubber holding portion and configured to come into contact with a windshield of a vehicle and remove foreign objects from the windshield, a connector arranged at a central portion of the support member and fixed to the spoiler member, and to which a wiper arm is coupled, a protruding stopper formed at one end portion of the spoiler member in a longitudinal direction and formed in a cantilever shape to protrude toward a center of the blade rubber in a width direction so as to limit movement of the blade rubber in the longitudinal direction of the spoiler member, and an engagement groove formed in the blade rubber and formed concavely to accommodate the protruding stopper.

The engagement groove may include a pair of partition walls spaced apart from each other so as to be caught by the protruding stopper and limit movement of the blade rubber to opposite sides of the spoiler member in the longitudinal direction.

The engagement groove and the protruding stopper may be provided as a pair symmetrically arranged to face each other in the width direction of the blade rubber.

A guide ramp may be formed near the engagement groove and may be formed to be inclined toward an entrance of the engagement groove as the guide ramp gets closer to the engagement groove from the connector.

The spoiler member may include a soft portion constituting upper and side portions of the support member and a hard portion facing a lower surface of the support member, the protruding stopper may be included in the hard portion, and hardness of the protruding stopper may be D43 to D63 in Shore hardness,

The flat wiper blade apparatus may further include end caps coupled to opposite end portions of the spoiler member.

The end caps may be arranged to cover the engagement groove and the protruding stopper.

The end cap may include a cantilever-shaped elastic hook that is elastically deformable in a thickness direction of the support member.

The support member may include a hook coupling hole coupled to the elastic hook.

The end cap may include a plurality of movement prevention protrusions supported at one end portion of the support member in a longitudinal direction and arranged to face the elastic hook.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of a flat wiper blade apparatus according to an embodiment;

FIG. 2 is an exploded perspective view of the flat wiper blade apparatus illustrated in FIG. 1;

FIG. 3 is a cross-sectional view taken along line III-III of FIG. 1;

FIG. 4 is a cross-sectional view taken along line IV-IV of FIG. 1;

FIG. 5 is a diagram schematically illustrating a state in which a blade rubber is assembled in a longitudinal direction of a spoiler in FIG. 3;

FIG. 6 is a cross-sectional view taken along line VI-VI of FIG. 1;

FIG. 7 is a cross-sectional view taken along line VII-VII of FIG. 4;

FIG. 8 is a diagram illustrating a three-dimensional shape of a protruding stopper formed on a spoiler member;

FIG. 9 is a diagram illustrating a three-dimensional shape of an engagement groove formed on a blade rubber; and

FIG. 10 is a diagram illustrating a three-dimensional shape of an elastic hook and a movement prevention protrusion formed on an end cap.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments will be described in detail with reference to the accompanying drawings, so that those of ordinary skill in the art may easily carry out the disclosure. However, the disclosure may be implemented in various different forms and is not limited to embodiments described herein. However, in describing embodiments in detail, when the detailed description of the relevant known functions or configurations is determined to unnecessarily obscure the gist of the disclosure, the detailed description thereof is omitted herein. In addition, parts that have similar functions and operations are denoted by the same reference numerals and/or symbols throughout the drawings.

It will be understood that the terms “comprise” or “include” as used herein specify the presence of stated elements, but do not preclude the presence or addition of one or more other elements. Specifically, the terms “comprise,” “include,” or “have” as used herein are inclusive and therefore specify the presence of one or more stated features, integers, steps, operations, elements, components, or any combination thereof, but do not preclude the presence or addition of one or more other features, integers, steps, operations, elements, components, or any combination thereof.

The singular forms as used herein are intended to include the plural forms as well unless the context clearly indicates otherwise. Furthermore, the shapes and sizes of elements in the drawing may be exaggerated for clearer explanation.

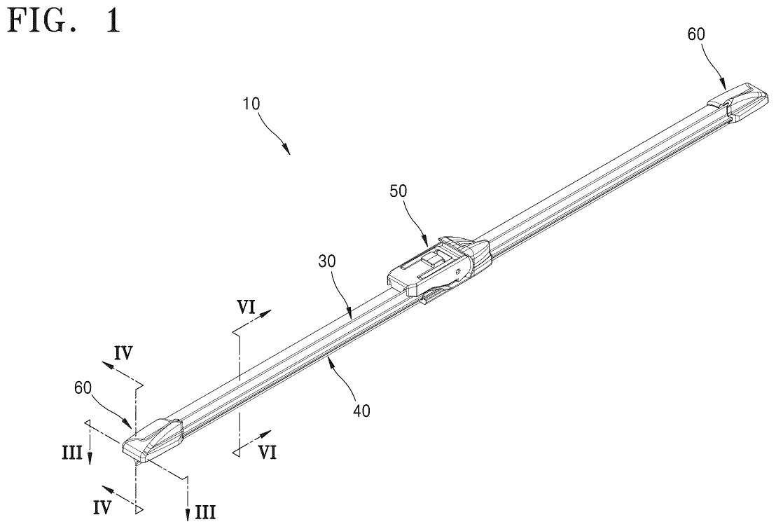

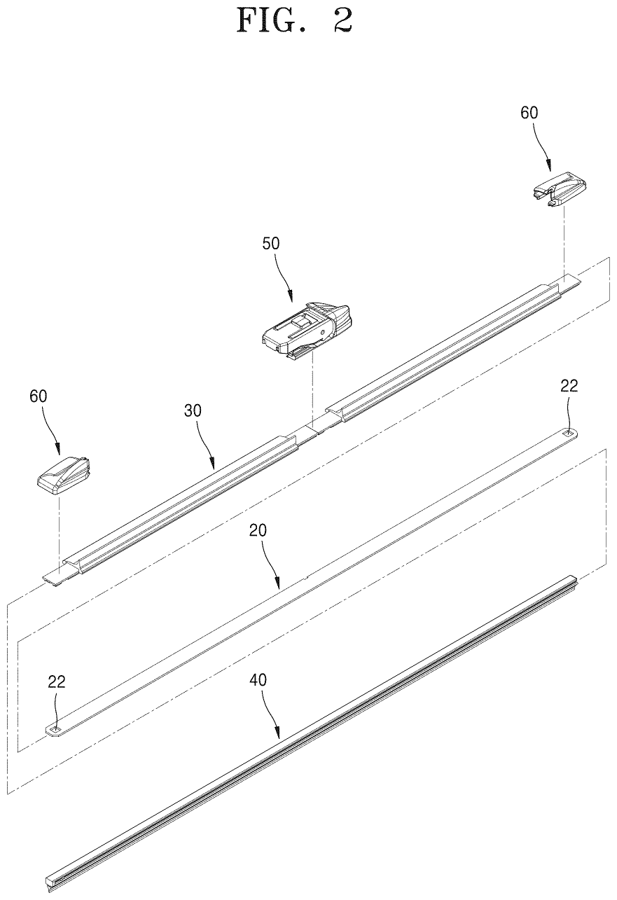

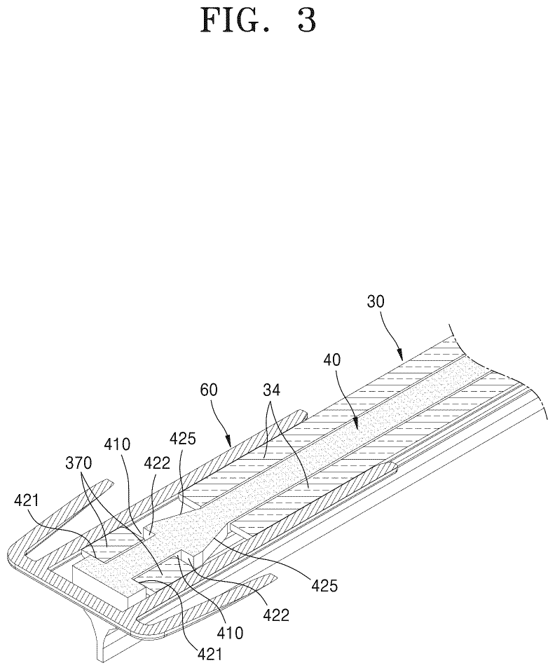

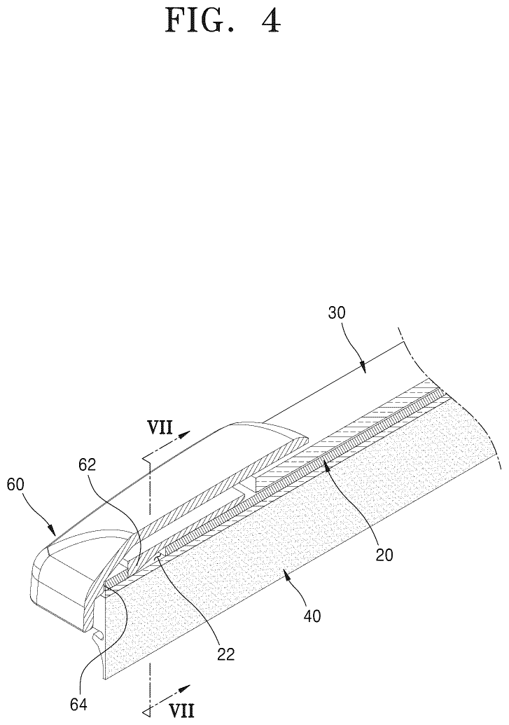

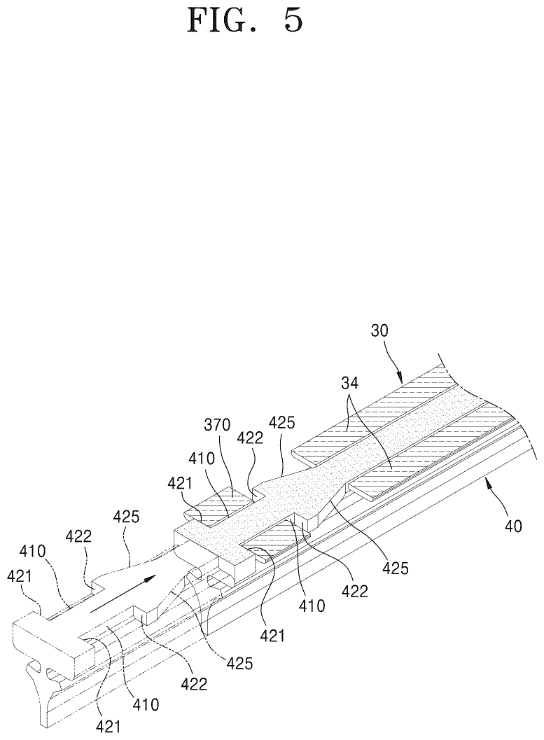

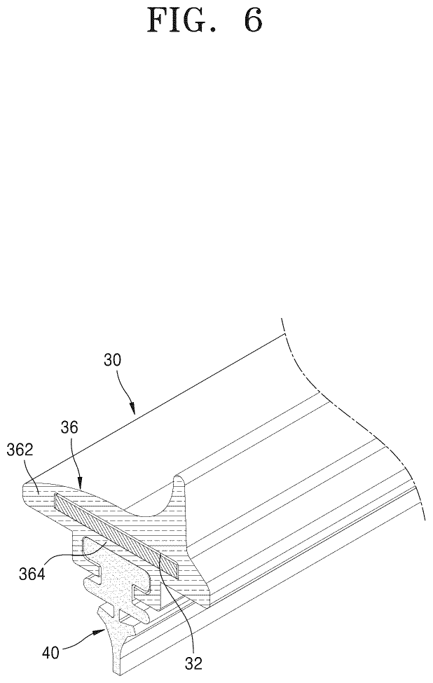

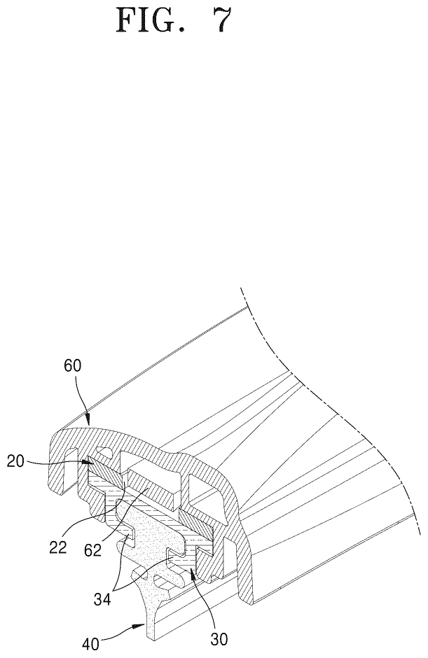

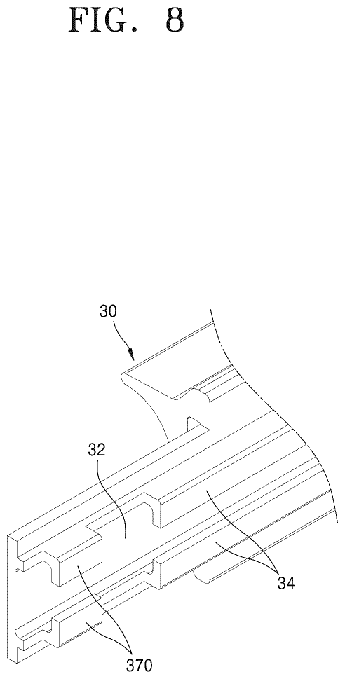

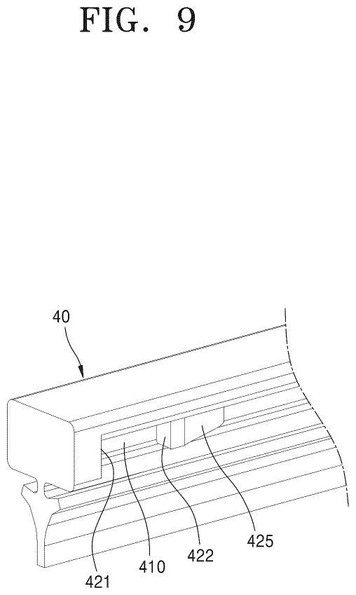

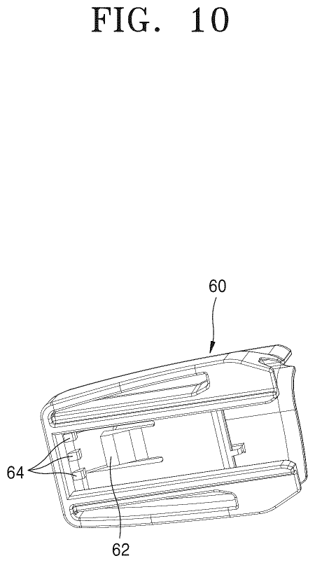

FIG. 1 is a perspective view of a flat wiper blade apparatus according to an embodiment. FIG. 2 is an exploded perspective view of the flat wiper blade apparatus illustrated in FIG. 1. FIG. 3 is a cross-sectional view taken along line III-III of FIG. 1. FIG. 4 is a cross-sectional view taken along line IV-IV of FIG. 1. FIG. 5 is a diagram schematically illustrating a state in which a blade rubber is assembled in a longitudinal direction of a spoiler in FIG. 3. FIG. 6 is a cross-sectional view taken along line VI-VI of FIG. 1. FIG. 7 is a cross-sectional view taken along line VII-VII of FIG. 4. FIG. 8 is a diagram illustrating a three-dimensional shape of a protruding stopper formed on a spoiler member. FIG. 9 is a diagram illustrating a three-dimensional shape of an engagement groove formed on a blade rubber. FIG. 10 is a diagram illustrating a three-dimensional shape of an elastic hook and a movement prevention protrusion formed on an end cap.

Referring to FIGS. 1 to 10, a flat wiper blade apparatus 10 with a longitudinal detachment prevention structure of a blade rubber (hereinafter referred to as a “flat wiper blade apparatus”), according to an embodiment, may include a support member (vertebra) 20, a spoiler member 30, a blade rubber 40, a connector 50, and end caps 60.

The support member 20 may include metal. The support member 20 may include, for example, stainless steel or carbon steel. The support member 20 may be formed by processing a plate-shaped metal into an elongated rod shape. The support member 20 may be employed to provide an elastic restoring force to the blade rubber 40 to be described below.

The spoiler member 30 may be formed of synthetic resin. The spoiler member 30 may perform multiple roles in the flat wiper blade apparatus 10. The spoiler member 30 may accommodate the support member 20. The spoiler member 30 may include a tunnel-shaped support member accommodation portion 32 to which the support member 20 is coupled. The support member accommodation portion 32 may be a hole penetrating in a longitudinal direction of the spoiler member 30.

The spoiler member 30 may include a blade rubber holding portion 34. The blade rubber holding portion 34 may be provided at a lower portion of the spoiler member 30. The blade rubber holding portion 34 may be configured in the form of a groove with an open bottom. The blade rubber 40 may be slidingly coupled to the blade rubber holding portion 34.

The spoiler member 30 may include a spoiler portion 36. The spoiler portion 36 may be formed at the upper end portion of the spoiler member 30. The spoiler portion 36 may have a shape to generate a pressing force downward of the spoiler member 30 due to air flow.

The spoiler member 30 may be provided in pair. The spoiler members 30 may be respectively arranged on opposite sides with respect to the center of the connector 50 to be described below.

The spoiler member 30 may include a soft portion 362 and a hard portion 364. The soft portion 362 may be arranged on the upper and side portions of the support member 20. The hard portion 364 may be arranged below the support member 20. The soft portion 362 and the hard portion 364 may be formed by processing synthetic resins of different materials through double extrusion.

The blade rubber 40 may include a material such as rubber. The blade rubber 40 may be coupled to the blade rubber holding portion 34. The blade rubber 40 may be coupled to the blade rubber holding portion 34 in a sliding structure. The blade rubber 40 may come into contact with the windshield of the vehicle and remove foreign objects from the windshield. The upper portion of the blade rubber 40 may be coupled to the blade rubber holding portion 34, and the lower portion of the blade rubber 40 may protrude toward the lower end of the spoiler member 30.

The connector 50 may be arranged in the central portion of the support member 20. The connector 50 may be arranged in the form of being coupled to the spoiler member 30. A wiper arm (not shown) may be coupled to the connector 50.

The connector 50 may allow the spoiler member 30 to be coupled. The connector 50 may include a plurality of members coupled to each other. The wiper arm (not shown) may be detachably coupled to the connector 50. The connector 50 may have a known structure.

The spoiler member 30 may include a protruding stopper 370.

The protruding stopper 370 may be formed at one end portion of the spoiler member 30 in the longitudinal direction. In case that the spoiler member 30 is provided in plurality, the protruding stopper 370 may be provided only on one spoiler member 30 arranged at one end portion of the spoiler member 30 in the longitudinal direction. The protruding stopper 370 may formed in a cantilever shape to protrude toward the center of the blade rubber 40 in a width direction. The protruding stopper 370 may be a structure designed to limit movement of the blade rubber 40 in the longitudinal direction of the spoiler member 30. A space may be provided between the protruding stopper 370 and the blade rubber holding portion 34. A guide ramp 425 to be described below may be inserted into the space between the protruding stopper 370 and the blade rubber holding portion 34.

The blade rubber 40 may include an engagement groove 410. The engagement groove 410 may be formed at a position corresponding to the protruding stopper 370. The engagement groove 410 may be a groove formed concavely to accommodate the protruding stopper 370 when the blade rubber 40 is in a state of being assembled to the spoiler member 30.

The engagement groove 410 may include a pair of partition walls 421 and 422. The pair of partition walls 421 and 422 may be caught by the protruding stopper 370 to limit movement of the blade rubber 40 to opposite sides of the spoiler member 30 in the longitudinal direction. Accordingly, the pair of partition walls 421 and 422 may be spaced apart from each other. A gap may be formed between the pair of partition walls 421 and 422 and the protruding stopper 370. The gap between the pair of partition walls 421 and 422 and the protruding stopper 370 may be a space where the blade rubber 40 is movable in the longitudinal direction of the spoiler member 30 when the blade rubber 40 is in a state of being assembled to the spoiler member 30.

The engagement groove 410 and the protruding stopper 370 may be provided as a pair symmetrically arranged to face each other in the width direction of the blade rubber 40. In this case, the protruding stopper 370 may be arranged in a sandwich shape with the blade rubber 40 therebetween.

The blade rubber 40 may include a guide ramp 425. The guide ramp 425 is a structure formed to be inclined along the longitudinal direction of the blade rubber 40. More specifically, the guide ramp 425 may be provided in a tapered shape. The guide ramp 425 may be formed near the engagement groove 410. The guide ramp 425 may be formed to be inclined toward an entrance of the engagement groove 410 as the guide ramp 425 gets closer to the engagement groove 410 from the connector 50. That is, the guide ramp 425 may be formed such that the thickness thereof gradually becomes thinner as the guide ramp 425 approaches the connector 50 from the engagement groove 410. The guide ramp 425 may guide the protruding stopper 370 so that the protruding stopper 370 may be naturally accommodated in the engagement groove 410 by being elastically pressed by the protruding stopper 370 during a process in which the blade rubber 40 is slidingly assembled to the spoiler member 30.

The spoiler member 30 may include the soft portion 362 and the hard portion 364.

The soft portion 362 may constitute the upper and side portions of the support member 20. The hard portion 364 may be arranged at a portion facing the lower surface of the support member 20. Therefore, the protruding stopper 370 may be included in the hard portion 364. The hardness of the protruding stopper 370 may be D43 to D63 in Shore hardness. The Shore hardness may be used as a criterion that measures the hardness of various materials, such as rubber, plastics, or elastomers. The Shore hardness may refer to a degree to which a material resists an external forces. The Shore hardness may be an important factor in evaluating the flexibility and durability of rubber and plastics. A device called a Shore durometer may be used to measure the Shore hardness. The Shore hardness may be classified into A hardness, D hardness, etc. For example, Shore A hardness indicates hardness of a soft material. Shore D hardness indicates hardness of a material that is harder than Shore A hardness. The Shore hardness may be measured by pressing a small metal tip attached to a measuring instrument against the surface of a material and determining how much the material resists the tip. As the hardness increases, the material is harder, and as the hardness decreases, the material is softer or more flexible. In case that the hardness of the protruding stopper 370 is less than D43, it may be difficult to sufficiently limit not only the longitudinal detachment but also detachments in two other directions of the blade rubber 40. Or, it may deteriorate curvature-following performance. In case that the hardness of the protruding stopper 370 is greater than D63, the protruding stopper 370 may break due to external impact.

The end caps 60 may be respectively coupled to opposite end portions of the spoiler member 30. The end cap 60 may be manufactured by injection-molding synthetic resin. The end cap 60 may be arranged to cover the engagement groove 410 and the protruding stopper 370. The end cap 60 may include a cantilever-shaped elastic hook 62 that is elastically deformable in the thickness direction of the support member 20. The support member 20 may have a hook coupling hole 22 coupled to the elastic hook 62. Because the elastic hook 62 is coupled to the hook coupling hole 22, the end cap 60 may be prevented from being detached in the longitudinal direction of the support member 20. In addition, the end cap 60 may include a plurality of movement prevention protrusions 64. The movement prevention protrusion 64 may limit movement of the end cap 60 in the longitudinal direction of the support member 20 when the end cap 60 is in a state of being coupled to the support member 20. The movement prevention protrusion 64 may be supported at one end portion of the support member 20 in the longitudinal direction. The movement prevention protrusion 64 may be arranged to face the elastic hook 62. The movement prevention protrusion 64 may limit the end cap 60 from moving toward the connector 50. The elastic hook 62 may limit the end cap 60 from moving away from the connector 50.

Hereinafter, the operational effect of the flat wiper blade apparatus 10 including the above-described components is described in detail by using the process of assembling the blade rubber 40 to the spoiler member 30 as an example.

It is assumed that the spoiler member 30, the support member 20, and the connector 50 are in a pre-assembled state. To assemble the blade rubber 40 to the spoiler member 30, the end portion of the blade rubber 40 where the engagement groove 410 is not provided may be arranged to approach the protruding stopper 370. In this state, the blade rubber 40 may be slidingly assembled to the blade rubber holding portion 34 of the spoiler member 30. In this process, the blade rubber 40 may be naturally slidingly assembled along the blade rubber holding portion 34. As illustrated in FIG. 5, when the blade rubber 40 is in an almost assembled state, the protruding stopper 370 may meet the guide ramp 425. As the guide ramp 425 passes through the protruding stopper 370, a higher pressing force may be applied to the guide ramp 425. As a result, the blade rubber 40 may be elastically deformed in the width direction. When the guide ramp 425 passes through the protruding stopper 370, the protruding stopper 370 may be in a state of being accommodated in the engagement groove 410. This state is a state in which the assembly of the blade rubber 40 is completed. In this state, the protruding stopper 370 may be caught by the partition wall of the engagement groove 410 formed in the blade rubber 40, and the movement of the blade rubber 40 may be limited from moving toward opposite sides of the spoiler member 30 in the longitudinal direction. The end cap 60 may be assembled to the end portion of the support member 20. In this process, the elastic hook 62 may be elastically deformed and coupled to the hook coupling hole 22. In addition, when the movement prevention protrusion 64 is supported at the end portion of the support member 20, the assembly of the end cap 60 may be completed. Through these processes, the flat wiper blade apparatus 10 may be completed.

The flat wiper blade apparatus 10 completed in this manner may be installed in a vehicle by coupling the connector 50 to a wiper arm provided in the vehicle. Due to the reciprocating rotational motion of the wiper arm, the flat wiper blade apparatus 10 may remove foreign objects from the windshield of the vehicle. Even when the end cap 60 is unexpectedly detached during this process, the blade rubber 40 may be effectively prevented from being detached in the longitudinal direction because the protruding stopper 370 provided in the spoiler member 30 is caught by the engagement groove 410.

As described above, the flat wiper blade apparatus according to the disclosure may be configured such that the cantilever-shaped protruding stopper formed on the spoiler member is accommodated in the engagement groove formed in the blade rubber. Accordingly, even when the end cap is detached, an effect of preventing the blade rubber from being detached in the longitudinal direction of the spoiler member may be provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A flat wiper blade apparatus with a longitudinal detachment prevention structure of a blade rubber, the flat wiper blade apparatus comprising:
a support member formed of a metal plate having an elongated bar shape;
a spoiler member comprising a tunnel-shaped support member accommodation portion to which the support member is coupled, a blade rubber holding portion arranged at a lower portion thereof and to which a blade rubber is slidingly coupled, and a spoiler portion arranged at an upper portion thereof and configured to generate a pressing force downward due to air flow;
a blade rubber coupled to the blade rubber holding portion and configured to come into contact with a windshield of a vehicle and remove foreign objects from the windshield;
a connector arranged at a central portion of the support member and fixed to the spoiler member, and to which a wiper arm is coupled;
a protruding stopper formed at one end portion of the spoiler member in a longitudinal direction and formed in a cantilever shape to protrude toward a center of the blade rubber in a width direction so as to limit movement of the blade rubber in the longitudinal direction of the spoiler member; and
an engagement groove formed in the blade rubber and formed concavely to accommodate the protruding stopper,
wherein the spoiler member comprises:
a soft portion constituting upper and side portions of the support member; and
a hard portion facing a lower surface of the support member,
the protruding stopper is included in the hard portion,
hardness of the protruding stopper is D43 to D63 in Shore hardness,
the soft portion and the hard portion are formed by processing synthetic resins of different materials through double extrusion,
a space is provided between the protruding stopper and the blade rubber holding portion, and
a guide ramp is inserted into the space between the protruding stopper and the blade rubber holding portion.

2. The flat wiper blade apparatus of claim 1, wherein the engagement groove comprises a pair of partition walls spaced apart from each other so as to be caught by the protruding stopper and limit movement of the blade rubber to opposite sides of the spoiler member in the longitudinal direction.

3. The flat wiper blade apparatus of claim 1, wherein the engagement groove and the protruding stopper are provided as a pair symmetrically arranged to face each other in the width direction of the blade rubber.

4. The flat wiper blade apparatus of claim 1, wherein the guide ramp is formed near the engagement groove and is formed to be inclined toward an entrance of the engagement groove as the guide ramp gets closer to the engagement groove from the connector.

5. The flat wiper blade apparatus of claim 1, further comprising end caps coupled to opposite end portions of the spoiler member,
wherein the end caps are arranged to cover the engagement groove and the protruding stopper.

6. The flat wiper blade apparatus of claim 5, wherein the end cap comprises a cantilever-shaped elastic hook that is elastically deformable in a thickness direction of the support member, and
the support member comprises a hook coupling hole coupled to the elastic hook.

7. The flat wiper blade apparatus of claim 6, wherein the end cap comprises a plurality of movement prevention protrusions supported at one end portion of the support member in a longitudinal direction and arranged to face the elastic hook.
